(19) United States
(12) Patent Application Publication
(10) Pub. No.: US 2003/0062305 A1
(43) Pub. Date: Apr. 3, 2003

(54) Biological processes

(76) Inventor: Boris M. Khudenko, Atlanta, GA (US)

Correspondence Address: Boris M. Khudenko, 744 Moores Mill Rd., Atlanta, GA, 30327, US

(21) Appl. No.: 09/966,825

(22) Filed: Sep. 29, 2001

(51) Int. Cl. C02F 3/00

(52) U.S. Cl. 210/603

(57) ABSTRACT

A method of biological treatment of wastewater laden with organics in a reactor having a biomass, the wastewater and biomass form mixed liquor, a treated wastewater, biological gases, and new biomass are generated in the reactor, biomass is separated from the treated wastewater by vaporization and condensation and is at least partially retained in the reactor, and further providing at least one step of physical-chemical treatment of said mixed liquor prior to the vaporization, whereby the free dissolved volatile gases are substantially removed from the mixed liquor and the efficiency of said biomass and wastewater separation by vaporization is improved. The main biological gases are carbon dioxide and methane. Carbon dioxide is converted into well soluble and non-volatile bicarbonates, poorly soluble methane is separated and collected from the bicarbonate rich mixed liquor as a methane-rich biogas, and carbon dioxide is than stripped by air by disproportionating bicarbonates into carbon dioxide and calcium carbonate in a carbon dioxide stripper.

### FIELD OF INVENTION

This is a method and apparatus for improving performance and the balance of energy, including usage of energy for operating processes and generation of energy as methane in biological systems for treatment of industrial and municipal wastewater, sludges, organic laden slurries including wastes from animal farms and agricultural waste, slurried and liquefied organic waste and other organic feedstock including harvested vegetation.

### PRIOR ART

Anaerobic processes have many advantages over aerobic processes. Particularly, anaerobic processes can be a net energy generators. They require less energy for operations and produce digestion gases with methane content from 30 to 65% depending on the nature of the feedstock and operating conditions. Other components of the digestion gases include carbon dioxide, water vapor, hydrogen sulfide, and sometimes ammonia and other gases. Admixtures to methane may be corrosive, may form pollutants on combustion, and may substantially reduce the heat value of the digestion gas.

Several improvements have been provided for the removal of hydrogen sulfide from the digestion gas and for increasing methane contents by reducing carbon dioxide in the digestion gases. Particularly, U.S. Pat. No. 5,798,043 describes a system for pH and alkalinity control in anaerobic processes which also produces high methane content digestion gas. U.S. Pat. No. 5,798,043 is made a part of this specification by inclusion. This is achieved by charging recuperable alkaline species (calcium, iron, and other ions) and stripping carbon dioxide from the liquid in the anaerobic reactor. Carbon dioxide stripping can be done by air, or vacuum. In the latter case, carbon dioxide is stripped into water vapor. This system had been very successfully used full-scale. However, design computations show that heat losses associated with carbon dioxide stripping, especially with vacuum, can be substantial. Additionally, utilization of the air-stripped carbon dioxide requires a very complex and expensive gas separation processes.

U.S. Pat. No. 6,291,232 describes a system of a water-vapor-stripping the anaerobic digestion gases which are made up of methane, carbon dioxide, hydrogen sulfide, and other gases. Thus stripped gas is separated by condensing water vapors followed by a further gas cooling and misting with clean chilled water. The gas separation, mainly as methane and as carbon dioxide and hydrogen sulfide, is achieved due to a very low solubility of methane in water at all temperatures and increasing carbon dioxide and hydrogen sulfide solubility at lower temperatures, for example, about 5° C. However, the solubilities given in this patent are valid for the pure-gas at one atmosphere pressure above the water phase. Methane is a substantial fraction of the actual gas above the water. Accordingly, the carbon dioxide solubility in chilled water is much less than that given in said patent. In the course of absorbing carbon dioxide from the digestion gas the proportion of methane in the gas contacting the chilled water increases and that of carbon dioxide decreases, thus making the carbon dioxide solubility in chilled water even smaller. Accordingly, very large quantity of chilled water is required for carbon dioxide absorption. This large quantity of chilled water is than reheated to release carbon dioxide. Large, complex, and expensive equipment is required for producing large quantities of chilled water, misting it to absorb carbon dioxide, reheating it and desorbing carbon dioxide. Additionally, hydrogen sulfide is also dissolved in chilled water and released upon heating together with carbon dioxide, thus resulting in a product carbon dioxide gas laced with a significant fraction of hydrogen sulfide, an obnoxious admixture, to say the least.

Heat losses across the reaction vessel enclosures can also be high, especially, in cold winters. For a given temperature differential inside the reactor (operable temperature) and outside the reactor (ambient temperature) the heat loss can be reduced by reducing the heat transfer rate across the enclosures (improving insulation) or by reducing the surface area (size) of the reactor. Reactor size can be reduced by reducing the retention time of liquid in the reactor.

Biological treatment processes also use energy for pumping liquids and sludges, heating and cooling water and sludge streams, gas pumping and compression, including air and/or oxygen, and other purposes. The greater the number of pumping, compression, heating, and cooling operations, the greater the energy use, as well as the complexity of the system.

The objective of the present invention is to provide a biological treatment system with improved heat balance due to generation of larger quantities of practically pure methane, due to reduction in the heat losses, and due to the reduction in energy requirements for pumping, compression, heating and cooling. Other objectives will become apparent from the ensuing specification.

### SUMMARY OF INVENTION

This is a method of biological treatment of organic laden water mixed with biomass, said organic laden water and said biomass forming a mixed liquor, comprising steps of:

a. at least one biological treatment step for treating said organic laden water with said biomass generating digestion gas consisting at least partially of methane and carbon dioxide and more biomass,

b. providing alkalinity in said water and chemically immobilizing said carbon dioxide as bicarbonates,

c. releasing and collecting substantially pure methane from said water treated in said step (a) and (b),

d. vapor stripping said chemically immobilized carbon dioxide by disproportionating bicarbonates into carbon dioxide and carbonates and generating water-vapor-carbon-dioxide stream.

The provided alkalinity converts volatile carbon dioxide into non-volatile bicarbonates, and to some extent even to carbonates. In the course of stripping carbon dioxide from the mixed liquor having predominantly dissolved bicarbonates, the bicarbonates disproportionate into carbon dioxide and carbonates. Carbon dioxide is stripped thus removing acidity from the mixed liquor. Simultaneously, the formation of carbonates increases the alkalinity of the mixed liquor.

The process is further improved by condensing and cooling said water-vapor-carbon-dioxide stream and forming a clean water stream with a small concentration of carbon dioxide and the bulk of gaseous carbon dioxide. Thus separated carbon dioxide may be utilized as a reagent. The process even further improved by condensing and cooling said water vapor in two steps, first, to a temperature slightly below boiling pont of water, and further cooling the condensate to a desired temperature. Solubility of carbon dioxide is very low at the first condensation and cooling step and separating carbon dioxide from the condensate at this temperature is the most complete. Accordingly, carbon dioxide is separated from the condensed water vapor at this temperature. Additional advantage of the two step condensation and cooling is that the final condensate carries very little carbon dioxide and has quite low acidity. The provided alkalinity, preferably, should include constituents, such as calcium and iron, or other, capable of precipitating sulfides. The process can be further improved by condensing said water-vapor by cooling it across a heat transfer surface by said organic laden water prior to said step (a) or within said step (a), or both. Thus said organic laden liquid is heated prior to sais step (a) or said mixed liquor is heated within said at least one biological treatment step for treating said organic laden water. Further, said water vapor can be generated by vacuuming said organic laden liquid or said mixed liquor by using means for producing vacuum. Further, the said water-vapor-carbon-dioxide stream can be recompressed with the following condensation by cooling said water-vapor either with said organic laden water prior to said step (a) or with said mixed liquor within or outside said step (a).

This is a method wherein said alkalinity can be (1) an intrinsic alkalinity, for example, formed in said step (a) by generating ammonia from organic nitrogen, or by reducing sulfates, or by other biological and physical-chemical processes, (2) an added non-recuperable alkalinity, for example, due to sodium hydroxide, and (3) a charged recuperable alkalinity, for example, due to calcium, iron, and other ions. In this method modification, sulfide ions are precipitated as insoluble compounds, thus efficiently separating hydrogen sulfide from methane and carbon dioxide.

This is a method of treating said organic laden liquid in steps (a) through (d) and further condensing the water-vapor, wherein at least a part of the said organic laden liquid is biologically treated in said step (a) and separated from said mixed liquor as treated effluent, and the balance of the said organic laden water undergoes steps of conversion to vapors with the help of said vacuum means and is converted to a clean water stream by means of recompression and condensation.

A portion of recompressed water vapor can be recycled to said step of vacuum generation of the water vapor for improving the turbulence and mass and heat transfer in the vacuum vaporization and vacuum stripping step.

More than one biological process steps can be included in said system. For example, a two step anaerobic system can be used. Both or ether of these steps can be run in thermophylic (40-65° C.), mesophylic (2545° C.), or psycrophylic regimes (0-30° C.). The vacuum stripping of carbon dioxide can be provided in at least one of these steps. The step of condensing said water vapor can be associated with any of these multiple biological process steps.

Biological process steps can be further selected from steps having a wide range of oxidation reduction potentials, for example, from those aerated with pure oxygen and having ORP=+200 mV to an iron reducing to elemental iron processes having ORP=−500 mV. These processes can be aided by providing oxidation reduction species incorporating iron, cobalt, nickel, manganese, chromium, and less common species as vanadium, arsenic, and others.

Biological process steps are further improved by providing contact media, either fixed or particulate. Fixed media can include various density packing made of corrugated plastic sheets and blocks, plastic mesh, socks and tubes made of plastic mesh, various shaped plastic goods, and from various baffles. Particulate media can be made of inert materials such as sand, crushed glass, anthracite, coal, plastic beads, etc. Particulate beds can be made of adsorption, ion exchange, oxidation-reduction resins, or other “reacting” media. Fixed and particulate media can be used together, as well as various mixtures of particulate media can be used.

The sludge mass is reduced, firstly, by using anaerobic processes instead of aerobic processes, secondly, by using intermittent aerobic-anaerobic sludge treatment. As oxidizers, air, oxygen and combinations thereof can be used as the ultimate oxidizers, while iron and/or other ions with variable valence can be used as intermediate oxidizers. Some aspects of this are described in the U.S. Pat. No. 5,919,367 which is made a part of this application by inclusion.

The water vapor stripping of carbon dioxide can be combined with air stripping.

### DESCRIPTION OF DRAWINGS

FIG. 1 is a single-reactor system for anaerobic treatment of organic laden water with production of pure methane and chemical separation of carbon dioxide making use of vacuum-stripping steam recompression technology.

FIG. 1 is a multistage reactor system for anaerobic treatment of organic laden water with production of pure methane and chemical separation of carbon dioxide.

FIG. 1 is an anaerobic-aerobic system for treatment of organic laden water with production of pure methane and chemical separation of carbon dioxide and sludge minimization.

### PREFERRED EMBODIMENTS

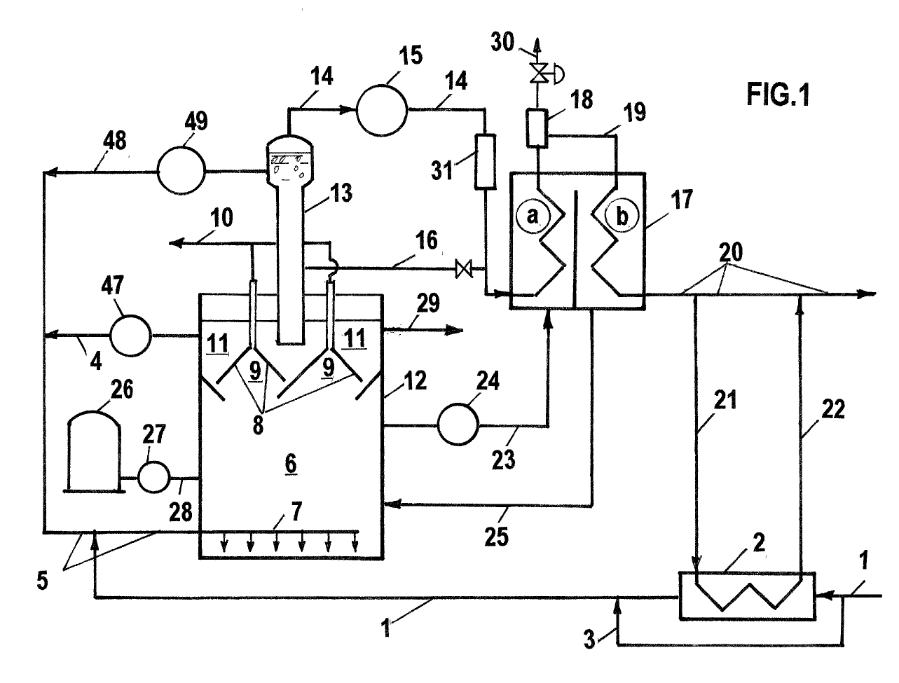

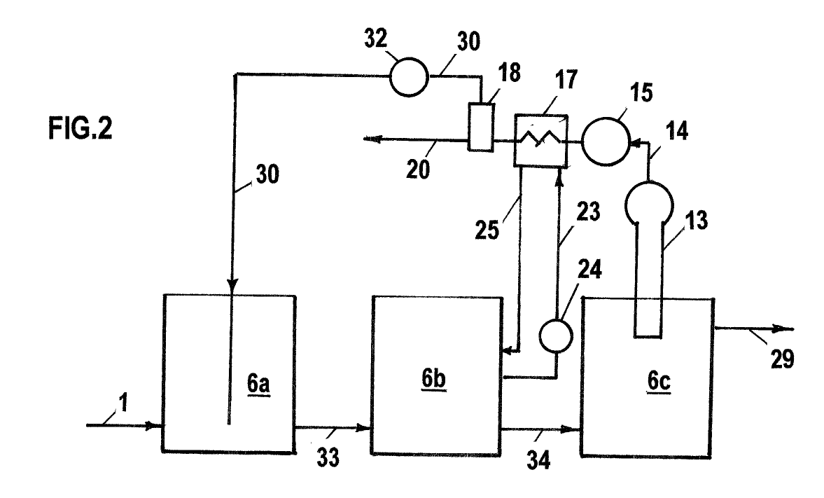

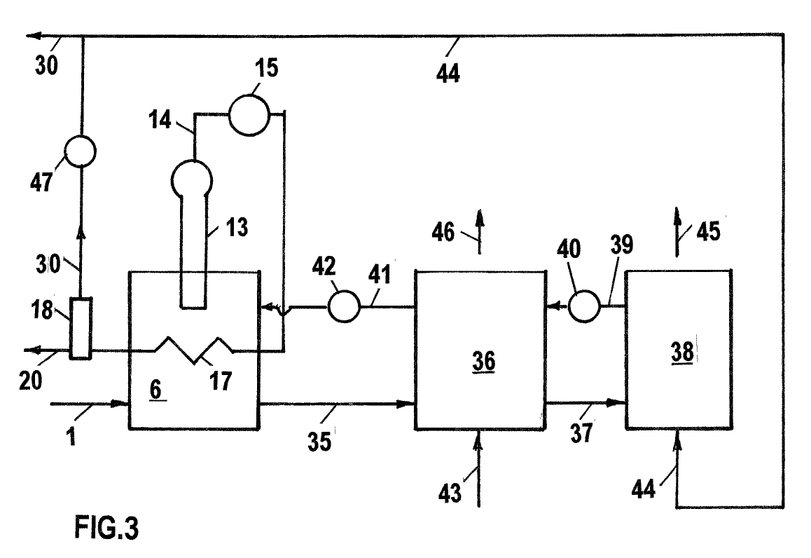

Referring now to FIG. 1 there is shown an anaerobic reactor 6 filled with mixed liquor containing water, biomass, and materials to be treated. Reactor 6 can be operated in the temperature range from few degrees Celsius to about 65° C. Reactions in the mixed liquor consume organic admixtures and produce in stages and phases solubilized organics from particulates, volatile fatty acids (VFA) from larger organic molecules, carbon dioxide, and methane. Additionally, some mineral constituents also take part in anaerobic transformations. Particularly important are oxidation-reduction processes (for example, reductions of sulfates and carbon dioxide to sulfides and methane, oxidation of ammonia and water to nitrogen and hydroxide ion). Acid-base transformations include changes in carbon dioxide-bicarbonate-carbonate, hydrosulfide-bisulfide-sulfide species. Precipitation of metals as carbonates and/or sulfides and gas releases, mainly methane, carbon dioxide, hydrogen sulfide, ammonia, hydrogen, nitrogen, also occur. In systems with active support particles, activated carbon, ion exchange resins, additional adsorption and ion exchange processes may occur. All these processes occur simultaneously and in a tight interaction with each other. Moreover, all this processes depend on the reactor hydraulics and effect hydraulics of the reactor. For example, sludge distribution in the reactor depends on the flows in the reactor, and the flows depend on the sludge distribution.

Reactor 6 has an influent line 1 directed through an optional heat exchanger 2 for a preheating, or a by-pass 3 when preheating is not provided, and connected to a reactor feed line 5 going to a flow distributor 7 inside the reactor 6. A line 4 with a pumping means 47 are provided for recycling mixed liquor within the reactor 6, mixing mixed liquor with the influent, and providing a portion of mixing action in the reactor. Additional mixing is provided by gases generated in the reactor 6. Reactor 6 is provided with at least one settling zone 11 formed by partitions 8. These partitions also form methane gas collection sections 9 with methane removal lines 10. Methane can be preferably utilized, released to the atmosphere, or flared.

During the start up, reactor 6 is charged with recuperable alkalinity providing species. A reagent supply means 26 and delivery means 27 with transmission lines 28 connected to the reactor 6 are provided for charging reagents. Calcium and iron ions are the most practicable species. At normal operable pH (6.6 to 7.6) carbon dioxide forms soluble and non-volatile bicarbonates of calcium and iron. When carbon dioxide is stripped from its bicarbonate solutions, bicarbonate disproportionates into carbon dioxide and carbonates. Calcium and iron carbonates precipitate into sludge as solid particles. In the course of biological reactions in the sludge particles, biologically formed carbon dioxide reacts with solid carbonate particles and forms dissolved and nonvolatile bicarbonates. Thus the carbon dioxide gassing and sludge flotation are avoided. Moreover, sludge loaded with calcium carbonate settles very well. Calcium and iron are cycled between carbonates and bicarbonates. Stripping of carbon dioxide can be provided immediately before the solid liquid separation in sections 11. Accordingly, carbonates will be formed and the bulk of calcium and iron will be precipitated, retained, and recuperated with the settled sludge. Small losses will be replenished with a small, possibly periodic, addition of lime and iron salts and lime. “Nonrecuperable” reagents such as sodium and potassium are also well retained in systems wich discharge all treated flow as the steam recompression condensate. Other reagents, such as nutrients and micronutrients may be needed in some cases. This is trivial and is not discussed here.

A vacuum stripping means 13 is provided at the top of reactor 6 for stripping carbon dioxide. A column with a dome is shown in this example. However, other arrangements are also possible, for example, the reactor 6 may have a vacuum dome covering the whole reactor. In such an arrangement, an upper portion of the reactor tank 12 will be under vacuum. The vacuum in column 13 is maintained by a vacuum-compressor 15 connected by lines 14 for the vacuum-vapor before column 15 and for the recompressed steam-carbon dioxide mixture after it. Carbon dioxide is well stripped due to a large flow of water vapor sucked by the vacuum compressor 15. Water vapor dilutes carbon dioxide and reduces its partial pressure over liquid in column 13, thus increasing the stripping efficiency. Single anaerobic reactor shall be provided with at least one vacuum means, like column 13. One or several vacuum-compressors can also be provided. An optional means 31 is provided for treatment of admixtures to the recompressed mixture. For example, means 13 can be a UV, ozone, a UV-ozone reactor, an electrochemical destructor, or a catalytic destructor, or other technology for oxidation and/or other degradation of residual volatile organics, preferably to carbon dioxide and water. After optional treatment, the recompressed steam is directed to a heat exchanger 17 optionally provided with two sequential sections a and b. The steam in the heat exchanger 17 is cooled by mixed liquor delivered via line 23 with a pump 24. The heated mixed liquor is returned to the reactor 6 via line 25. In section a, the steam is condensed and cooled to a temperature close to a boiling point. At this temperature solubility of carbon dioxide in condensate is very low. Accordingly, carbon dioxide can be very efficiently separated from the condensate. This is done in a gas separator 18. Carbon dioxide is further evacuated for discharge or utilization via line 30 with a pressure regulator. The condensate is directed to the section b of the heat exchanger 17 for farther harvesting of heat. Alternatively, further heat harvesting can be combined with preheating of the influent in exchanger 2. If the influent is cool, a substantial heat utilization can be achieved. A line 16 for recycling a portion of the recompressed steam to the column 13 is provided for creating bubbles and the mass transfer surface in column 13 as well as for providing turbulence. A portion of mixed liquor enriched with carbonates is transferred from the stripping column 13 via line 48 with pumping means 49 to the reactor 6. Thus carbonates are provided in the space where carbon dioxide is formed and is neutralized by conversion to well soluble bicarbonates.

Maintaining pH range at which most of carbon dioxide is converted into bicarbonates results in clean methane release in the reactor 6. Accordingly, carbon dioxide is virtually absent or present in very low quantities in the gas collection zones 9. It becomes very practicable to produce 90 to 95% methane content in the harvested gas. The harvested gas may also contain some nitrogen and hydrogen. At the same time, methane content in the mixed liquid passing through the vacuum column 13 is very low and carbon dioxide gas separated from the condensed and cooled recompressed steam is very clean. These gases may be beneficially utilized. At pH range wherein bicarbonates and carbonates prevail and also in presence of large calcium and iron concentrations, sulfides are precipitated as insoluble metal salts.

Depending on the heat balance and particular objectives of the system, the treated effluent can be any combination of treated wastewater flows after sludge separators, line 29, and after heat exchanger 17, line 20. Ultimately, all effluent can be the condensate of the recompressed steam. Considering the fact that many volatile organics are present in the reactor 6 at least in small quantities, some pollutants may be present in this condensate, unless specially treated, like in unit 31 here. Similarly, flows after clarifiers, line 29, may have various concentrations of admixtures needing additional treatment.

The described system can be used for treatment of dilute and concentrated wastewater, wastewater sludges, slurries at animal farms, slurried and solubilized agricultural waste, sorted and shredded organic fraction of garbage and yard waste, harvested sea weeds and other vegetation. The objectives of such a system can be waste treatment, gases, and energy production.

Referring now to FIG. 2, there is shown a multistage reactor system utilizing some of the features discussed above for the first embodiment. Accordingly, many details previously described will not be repeated. The system consists of an optional acidification reactor 6A fed with the influent via line 1 and connected by line 33 to a first stage anaerobic thermophylic reactor 6B, which in turn is connected via line 34 to the second stage anaerobic mesophylic reactor 6C. Reactor 6C is provided with a vacuum stripping column 13, a line 14, a vacuum-compressor 15, a heat exchanger 17, a carbon dioxide separator 18, a line for condensate discharge 20, and line 30 with compressor 32 for feeding carbon dioxide in reactor 6A. At least a portion of biologically treated wastewater can be discharged via line 29. Heat exchanger 17 is cooled by mixed liquor delivered from reactor 6B via line 23 and pumping means 24. This mixed liquor is returned back to reactor 6B. Such vacuum stripping in reactor 6C lowers the reactor 6C temperature, for example to mesophylic range, and the use of mixed liquor from the reactor 6B for condensing the recompressed steam transfers the heat in reactor 6B thus increasing its temperature to possibly a thermophylic range. Transfer of carbonc acid in reactor 6A may lower pH in this reactor thus providing improvements in acidic hydrolysis of particulate matter in the influent. If needed, reactor 6A can be heated instead of the reactor 6B, thus further improving the hydrolysis. Moreover, such heating may increase the temperature above the thermophylic range. One application of this process may be a treatment of organic solid materials in a leach step 6A with increased acidity due to carbon dioxide transfer and increased temperature, if recirculated leachate is used for cooling the heat exchanger 17. A portion of such leachate may be fed via line 33 in the subsequent process stages for methane generation and carbon dioxide separation. This embodiment illustrates a simple arrangement of providing convenient and economical means of manipulating with chemical, physical-chemical, and biological processes in biological treatment systems while focusing on particular objectives of the process. Many various applications can be developed without departure from the teachings presented herein.

Optionally, the heated liquor can be fed in or split among either of reactors 6A, 6B, and 6C. Also optionally, recycle of the treated effluents among reactors 6A, 6B, and 6C may be used as appropriate for particular application of the process.

FIG. 3 illustrates an anaerobic-aerobic system comprising anaerobic reactor 6 fed with influent via line 1 and further connected by line 35 to an aerobic reactor 36, wherein air, and/or oxygen are used as primary oxidizers fed in recator 36 through line 43. The off-gas from the reactor is the stream 46, which may go in the atmosphere, or may be intercepted. Aerobic reactor 36 is connected to an anoxic reactor 38 by line 37. Anoxic reactor 38 is also fed with carbon dioxide to lower its pH. Mixed liquors from reactors 38 and 36 are recycled back to reactors 36 and 6 by lines 39 with a pumping means 40 and line 41 with a pumping means 42. Reactor 6 is provided with a system for collecting clean methane and for vacuum stripping of bound carbon dioxide as previously described. Unlike in FIGS. 1 and 2, the heat exchanger 17 is submerged into reactor 6, otherwise the carbon dioxide stripping and the steam recompression system is the same as previously described.

The system of FIG. 3 is also charged with calcium and iron ions. Unlike in FIGS. 1 and 2, iron in this system plays a role in the oxidation-reduction processes. In the aerobic reactor 36, iron is oxidized by the oxygen of air, or oxygen of a pure industrial gas and a high concentration of ferric ions is built up. This process goes well at higher pH values, for example, greater than 6.8, but preferably at even greater levels. It is convenient to maintain highher pH in reactor 36 because it is fed with carbon dioxide-stripped and VFA-consumed mixed liquor in the reactor 6.

Moreover, this liquor is enriched with bicarbonates and carbonates. Accordingly, acidity produced on oxidation of ferrous ions to ferric is buffered. In anoxic reactor 38, the mixed liquor is provided with carbon dioxide supplied from the reactor 6 via the vacuum stripping system and further by a compressor 47 via line 44. Accordingly, ferric ions oxidize organics, which are mostly biomass, and thus reduce the biomass generated in the treatment system overall. Acidic conditions, such as provided by the carbon dioxide feed are favorable for the reduction of ferric ions to ferrous and for respective biomass oxidation. The process can be run at elevated temperatures in all reactor stages, for example in the thermophylic range. The process rates and efficiencies are greater at greater temperatures. This is an example of a combination of anaerobic and aerobic process steps making use of the present invention.

It should be note that in all described embodiments, if the effluent is constituted solely by distillate from the vacuum-stripping system, the losses of alkalinity from the system may be very small regardless of the type of alkali. Accordingly, even sodium or potassium ions will be largely retained in the system due to mechanical reasons. Hence, besides lime, iron, cobalt, and nickel ions (chemically recuperable) these alkali sources can also be used. This invention can be applied to separate aerobic processes. Particularly, vacuum stripping carbon dioxide in the pure oxygen activated sludge can be as beneficial as in the previously described anaerobic processes. It can also be used for treatment of dilute and concentrated waste in steps like reactors 36 and 38 in FIG. 3 (without reactor 6) wherein vacuum stripping is applied to the reactor step 36 for removing carbon dioxide followed by the transfer of carbon dioxide in the reactor 38. Other elements, for example sludge conditioning as described in the U.S. Pat. No. 5,514,277 can be used together with the present invention. This patent is made a part of present application by inclusion.

While the invention has been described in detail with particular reference to some embodiments thereof which can be presently preferred, it will be understood that variations and modifications can be effected within the spirit and scope of of the invention as previously described and as and as defined by the claims.

1. A method of biological treatment of organic laden water mixed with biomass, said organic laden water and said biomass forming a mixed liquor, comprising steps of:
a. At least one biological treatment step for treating said mixed liquor and generating digestion gas consisting at least partially of methane and carbon dioxide and generating more biomass,
b. Providing alkalinity in said water and chemically immobilizing carbon dioxide in form of bicarbonates and carbonates,
c. Releasing and collecting substantially puremethane from said mixed liquor treated in steps a and b,
d. Vacuum-stripping said chemically immobilized carbon dioxide by disproportionating said bicarbonates into carbon dioxide and carbonates and forming water vapors from said mixed liquor, whereby said water vapors carry vacuum-stripped carbon dioxide,
e. Recompressing said water vapors and said vacuum-stripped carbon dioxide,
f. Condensing, cooling, and utilizing the heat of said recompressed water vapors and separating gaseous carbon dioxide.

2. A method of biological treatment of wastewater laden with organics in a reactor having a biomass, said wastewater and said biomass form mixed liquor, a treated wastewater, biological gases, and new biomass are generated in said reactor, said biomass is separated from said treated wastewater and at least partially retained in said reactor, biomass is separated from said treated wastewater and at least partially retained in said reactor, and further providing
(a) at least one step of physical-chemical treatment of said mixed liquor prior said biomass separation, whereby the efficiency of said biomass and wastewater separation is improved, and
(b) separating said biomass from said treated wastewater by vaporization.

3. The method of claim 2, wherein said biological treatment is selected from the group including a range of biological processes from pure oxygen (+200 mV) to iron reducing (−500 mV) oxidation-reducing conditions, and combinations thereof.

4. The method of claim 2, wherein said biological treatment is selected from the group including thermophylic processes, mesophylic processes, psychrophylic processes, and combinations thereof.

5. The method of claim 2, wherein said biological treatment is selected from the group including processes with suspended biomass and processes with contact media, and combinations thereof.

6. The method of claim 5, wherein said contact media is selected from the group including fixed media, particulate media, and combinations thereof.

7. The method of claim 6, wherein said fixed media is selected from the group including corrugated sheets, corrugated blocks, mesh, socks made of mesh, tubes made of mesh, shaped plastic goods, baffles, and combinations thereof.

8. The method of claim 6, wherein said particulate media is selected from the group including inert materials, sand, crushed glass, anthracite, coal, plastic beads, reactive media, adsorption media, ion exchange media, oxidation-reduction resin, and combinations thereof.

9. The method of claim 1, wherein said at least one step of physical-chemical treatment is selected from the group including stripping carbon dioxide, providing alkalinity, providing alkalinity and stripping carbon dioxide, providing recuperable alkaline species and stripping carbon dioxide, providing recuperable oxidation-reduction species, providing recuperable oxidation-reduction species and a ultimate oxidizer, providing air, providing oxygen, providing intermediate oxidizers, providing iron, and combinations thereof.

10. The method of claim 9, wherein said step of providing alkalinity is selected from the group including providing an intrinsic alkalinity, generating ammonia from organic nitrogen, reducing sulfates, providing added non-recuperable alkalinity, adding sodium hydroxide, charging recuperable alkalinity, charging calcium, charging iron, and combinations thereof.

11. The method of claim 2, wherein said step of vaporization is selected from the group consisting of vaporization due to heating of the influent, vaporizartion due to heating of mixed liquor, vaporization due to vacuum evacuation of water-vapors from said mixed liquor, and combinations thereof.

12. The method of claim 11, wherein said heating of said mixed liquor is selected from a group consisting of heating by condensing said water-vapors and transferring heat to said mixed liquor, bioheating, and combinations thereof.

13. The method of claim 11, wherein said bioheating is selected from a gruop consisting of heat production by aeration of said mixed liquor with air, by aeration of said mixed liquor with oxygen, by oxidation using ultimate and intermediate oxidizers, and combinations thereof.

14. The method of claim 11, wherein said heating of said influent is provided by condensing said water-vapors and transferring heat to said influent.

15. The method of claim 11, wherein said vacuum vaporization is selected from the group consisting of vacuum generation due to vapor condensation, vacuum generation by a mechanical vacuum generation means, vacuum generation by a mechanical vacuum generation-steam recompression means, and combination thereof.

16. The method of claim 15, wherein said vapor condensation step is selected from a group consisting of vapor condensation in a heat exchanger with said wastewater as a cooling agent, vapor condensation in an outside heat exchanger with said mixed liquor as a cooling agent, vapor condensation in a heat exchanger submerged in said reactor with said mixed liquor as a cooling agent, and combinations thereof.

17. The process of claim 2 and further providing at least one step of separating said biological gases from said mixed liquor prior to said step of vaporization, whereby said biological gases include carbon dioxide, methane, hydrogen sulfide, ammonia, and combinations thereof.

18. The process of claim 17, wherein a step of conversion of gaseous carbon dioxide into water soluble bicarbonates and a step of conversion of hydrogen sulfide into insoluble metal sulfides are provided and said gaseous methane is collected and separated, whereby a methane-rich gas is produced.

19. The method of claim 17, wherein a step of stripping carbon dioxide is provided, said stripping is selected from the group consisting of stripping carbon dioxide with air, providing alkalinity and stripping carbon dioxide with air, providing recuperabble alkaline species and stripping carbon dioxide with air, vacuum-stripping carbon dioxide, and combinations thereof.

20. The method of claim 17, wherein said ammonia is treated by a method selected from a group consisting of oxidation of ammonia to nitrogen by intermediate oxidizers, collecting of ammonia together with methane, whereby a mixture of said ammonia and said methane form a combustion gas, and combination thereof.

21. A method of claim 9 and further providing a step of collecting methane-rich biogas.

22. A method of biological treatment of wastewater laden with organics in a reactor having a biomass, said wastewater and said biomass form mixed liquor, a treated wastewater, biological gases at least partially dissolved in said mixed liquor, and new biomass are generated in said reactor, biomass is separated from said treated wastewater and at least partially retained in said reactor, and and further providing steps of
(a) at least partially removing said dissolved biological gases from said mixed liquor and producing at least partially degassed said mixed liquor, and
(b) separating said biomass from said treated wastewater by vaporization.
